(19) United States
(12) Patent Application Publication
(10) Pub. No.: US 2003/0159330 A1
(43) Pub. Date: Aug. 28, 2003

(54) Fishing lure ridged head

(76) Inventor: Benjamin C. Roemer, Manitowish Waters, WI (US)

Correspondence Address: RYAN KROMHOLZ & MANION, S.C., Post Office Box 26618, Milwaukee, WI, 53226-0618, US

(21) Appl. No.: 10/081,171

(22) Filed: Feb. 22, 2002

(51) Int. Cl. A01K 83/06

(52) U.S. Cl. 43/44.8

(57) ABSTRACT

A fishing lure designed to improve the effectiveness of baits, such as tendril skirts and artificial grub attachments in attracting fish to attack. The fishing lure is designed with a large head and a long elongated body with ridges extending along its length. In between the head and the elongated, ridged body is a short concentric body to hold a bait, such as a skirt of tendrils. The ridges along the elongated body are designed to created optimum friction between the weight and grub, thereby preventing the artificial grub from slipping off or spinning around the weight.

### FIELD OF THE INVENTION

This invention relates to an apparatus for providing improved an fishing lure.

### BACKGROUND OF THE INVENTION

The spinner bait is a known fishing lure, consisting of a V-shaped wire frame with one or more legs and an eye located at the vertex of the V-shaped wire member. Attached to one of the legs of the wire frame are rotatable metal blades or spoons, while attached to the other leg is a weight affixed to a hook. Commonly, a skirt of tendrils and an artificial grub are placed about over the weight and affixed hook. During retrieval of the lure through the water, the spinners (the blades/spoons), tendrils and grub move about, reflecting light in a variety of directions as well as creating vibrations and visual depictions that stimulate fish to bite.

One problem in the prior art is that the skirt and artificial grub tend to slip off or around the shank of the hook, diminishing the overall lure's effectiveness in attracting fish.

### SUMMARY OF THE INVENTION

This invention is directed toward a weight of a fishing lure that offers markedly improved performance in holding the skirt of tendrils and artificial grub in-place. The weight consists of a variably shaped (e.g., ovular, spherical, non-concentric, minnow shaped, etc.) body of weighted material at the head, commonly lead, a narrow body for placement of the skirt, followed by an elongated body with ridges or fins for holding the grub.

The ridges along the elongated section of the weight are designed to prevent the artificial grub from spinning in place or slipping off the weight to the hook and the hook shank.

In particular, this weight is designed for use on a spinner-bait lure, but this design is not limited from use or incorporation with other fishing lures.

### DESCRIPTION OF DRAWINGS

FIG.1 is a schematic representation of spinner bait fishing lure with a weight, fish shield, and spinner/blade accessories.

FIG. 2 is an isolated schematic representation of the weight.

FIG. 3 is a cross sectional view of the elongated body of the weight.

FIG. 4 is a schematic representation of the weight in a typical application with a spinner bait lure with tendrils and artificial grub accessories.

### DETAILED DESCRIPTION

Referring to FIG. 1, the invention is directed to a weight 15 (shown in solid line) for use on a fishing lure 10. The remainder of the fishing lure 10, not being part of the invention, are shown in dashed lines.

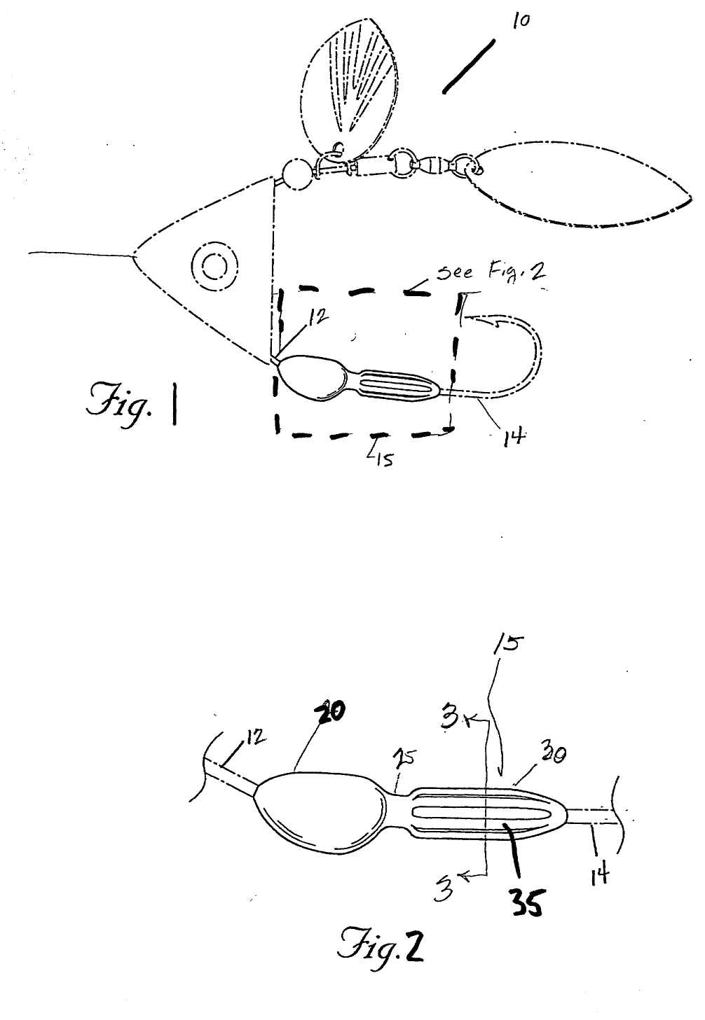

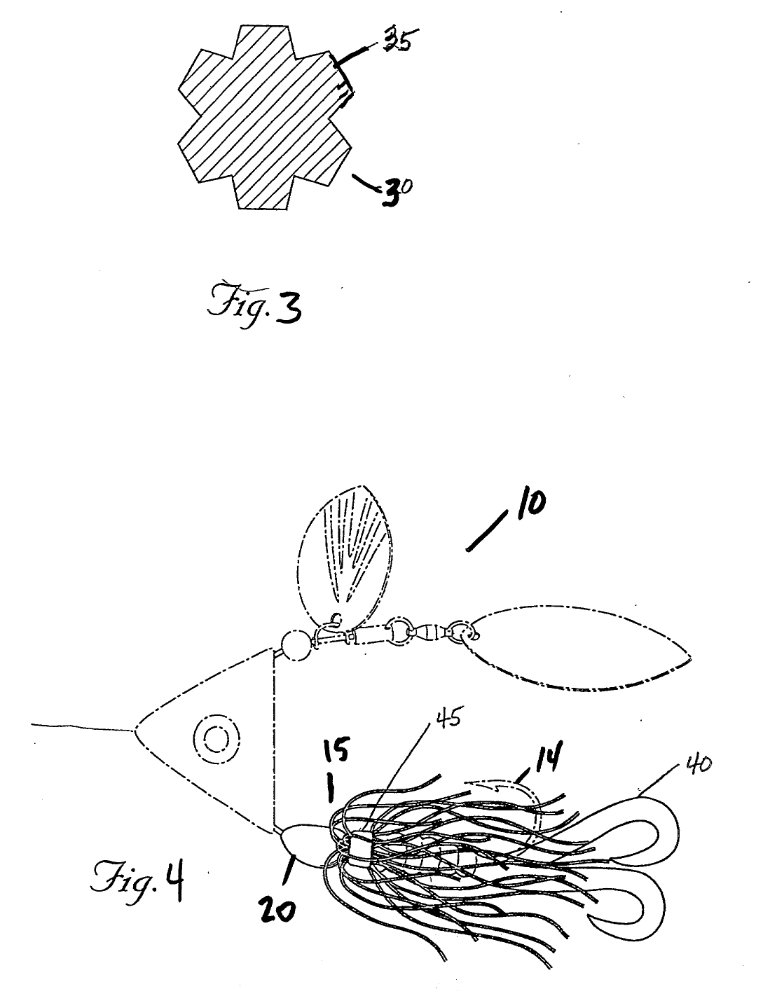

Referring to FIGS. 2 and 3, the weight 15 is comprised of a generally ovular-shaped head body 20, an elongated body 30, and a narrow, concentric body 25 located between the head body 20 and elongated body 30. The elongated body 30 of the weight 15 features multiple ridges 35 that extend, preferably radially, along the length of the elongated body 30. The purpose of the ridges 35 is to prevent an attached artificial grub 40 (grub 40 shown in FIG. 4), or other bait material from slipping off or spinning around the weight 15. The narrow concentric body 25 is of diameter for holding a skirt of tendrils 45 (tendrils 45 shown in FIG. 4), or other bait material in-place in a pre-determined position, preferably between the head body 20 and the elongated body 30. Although I have referred to a grub 40 and tendrils 45, it is understood that the grub 40 and tendrils 45 are merely exemplary of any number of live or artificial baits that may be placed about the weight 15.

In a preferred embodiment shown in FIG. 1, the weight 15 is affixed (e.g., molded) to a spinner bait wire frame 12 at the head body 20 and the opposite end of the elongated body 30 is affixed to a shank portion of a hook 14. In another preferred embodiment, the weight 15 is made of lead or other heavy metal material. The head body 20 is preferably ovular-shaped and the heaviest part of the weight 15. Adjacent to the head body 20 is a narrow, concentric body 25 of diameter that holds a skirt of tendrils 45 in-place. Following the narrow, concentric body 25 is an elongated body 30 with ridges 35 radially extending along its length. In a preferred embodiment, six ridges are utilized, although more or less could be used in accordance with manufacturer/user preference. FIG. 3 illustrates a preferred embodiment where the ridges 35 are flat at the outer radial edges to optimize the friction with an artificial grub 40, thereby preventing the grub 40 from slipping around or off the weight 15. In the preferred embodiment shown in FIG. 4, the skirt of tendrils 45 slip over the elongated, ridged body 30 onto the narrow, concentric body 25, held in-place between the head body 20 and the elongated, ridged body 30. Next, an artificial grub 40 would slip on the elongated body 30 of the weight 15 and held in-place from slipping by the radial ridges 35.

The above described embodiments of this invention are merely descriptive of its principles and are not to be limited. The scope of this invention instead shall be determined from the scope of the following claims, including their equivalents.

We claim:

1. A fishing lure comprising:
an elongated body with at least one ridge radially extending from said elongated body;
said elongated body coupled with a fishing hook.

2. A fishing lure according to claim 1, the lure further comprising:
a head body;
a narrow concentric body located between said head body and said elongated body adapted for holding a bait in-place between said head body and said elongated body.

3. A fishing lure according to claim 1, wherein said elongated body comprises lead.

4. A fishing lure according to claim 1 wherein said fishing lure is a spinner bait fishing lure.

5. A fishing lure according to claim 1 wherein said ridge radially extends from the elongated body.

6. A fishing lure according to claim 1 wherein said ridge is flat at an outer edge of said ridge.

7. A weight according to claim 1 where said bait slips over said narrow, concentric body and remains relatively stationary during use.
